(19) United States
(12) Patent Application Publication
(10) Pub. No.: US 2021/0120831 A1
(43) Pub. Date: Apr. 29, 2021

(54) GREEN COLOR-PROTECTING BACTERIOSTATIC CRISP-PRESERVING FRESH-CUT SWEETHEART APPLE AND BIOLOGICAL PRESERVATION TECHNOLOGY

(71) Applicant: SDIC ZHONGLU FRUIT JUICE CO., LTD., Beijing (CN)

(72) Inventors: Jiming ZHANG, BEIJING (CN); Chuanzhu LENG, BEIJING (CN); Xihong LI, BEIJING (CN); Gang XIN, BEIJING (CN); Xinfei SONG, BEIJING (CN); Baoshuang TIAN, BEIJING (CN); Nan JIANG, BEIJING (CN); Qingfei CAO, BEIJING (CN); Rui HUANG, BEIJING (CN); Ziyun LIU, BEIJING (CN); Qingshan ZHANG, BEIJING (CN); Xiangyang ZHENG, WEIHAI (CN)

(21) Appl. No.: 17/072,791

(22) Filed: Oct. 16, 2020

(30) Foreign Application Priority Data
Oct. 25, 2019 (CN) 201911020712.9

(51) Int. Cl. A23B 7/154; A23B 7/157; A23B 7/16; A23B 7/015

(52) U.S. Cl. CPC A23B 7/154; A23B 7/157; A23Y 2220/67; A23B 7/015; A23V 2002/00; A23B 7/16

(57) ABSTRACT

The present disclosure relates to a green color-protecting bacteriostatic crisp-preserving fresh-cut sweetheart apple and biological preservation technology. Two fermentation liquids of Xanthomonas campestris and Lactobacillus plantarum are separately fermented, and are removal of the bacterial species, and then mixed in the ratio of 1:1 to obtain a bacterial solution, the bacterial solution is diluted 20-30 times for use, and then calcium chloride with a final concentration of 1-5 wt % is added to the bacterial solution. The extracellular polysaccharide produced by the metabolism of xanthomonas in the fresh keeping agent in the present disclosure is a safe food additive, which has good film-forming, thickening, stabilizing and water-holding effects, and strong biological activity. Acidic substances produced by the metabolism of Lactobacillus plantarum have bacteriostatic effects. Besides, calcium is a common substance used to keep the fruits and vegetables crisp after harvest.

### CROSS-REFERENCE TO RELATED APPLICATIONS

This application claims priority to Chinese Patent Application No. 201911020712.9 with a filing date of Oct. 25, 2019. The content of the aforementioned applications, including any intervening amendments thereto, are incorporated herein by reference.

### TECHNICAL FIELD

The present disclosure relates to the field of fresh-cut fruits, and particularly relates to a green color-protecting bacteriostatic crisp-preserving fresh-cut sweetheart apple and biological preservation technology.

### BACKGROUND OF THE PRESENT INVENTION

Fresh-cut fruits are widely loved by consumers for their convenience, freshness, nutrition and safety. However, the original protective layer is removed and the pulp tissue is exposed after the fruit is cut. Microorganisms can easily contaminate the fruit through the cut, and the cutting process causes the outflow of nutrients in the fruit which provides favorable environmental conditions for the growth and reproduction of microorganisms. With the increase of the amount of microorganisms, spoilage symptoms will appear, browning and decay softening of the fresh-cut fruits will become obvious, resulting in a significant reduction in the fresh quality and nutritional value of the fresh-cut fruits, and the hygienic safety of the fruits cannot be guaranteed. In addition, due to the adversity caused by the cutting injury, a series of physiological and biochemical reactions such as ethylene production, increased breathing strength, accelerated transpiration, and enzymatic browning have been accelerated in fruit and vegetable tissues, accelerating the process of tissue aging.

Under the combined influence of the above-mentioned microbial infection and tissue aging, the quality of the fresh-cut fruits and vegetables has been deteriorated, the shelf life has been shortened, and the commercial value of the fresh-cut fruits has been reduced. Therefore, in order to prevent or slow down the browning and hardness reduction of the fresh; cut apples under the influence of microbial infection and tissue aging, a new type of coating solution that mainly includes microbial metabolites and calcium ions has been developed in the disclosure. By combining the CO 2 inflatable packaging and the ionizing radiation sterilization technology, a new method can be obtained to efficiently delay the substance loss of the fresh-cut fruits and the microorganism infection, aiming at preserving the color and keeping the crispness of the fresh-cut apples.

The disclosures related to the present application are as follows.

In a first compared patent “A Preservative and Color-protecting Composition, a Preservative and Color-protecting Solution and a Method for Processing and Preserving Fresh-cut Apples” numbered ZL201810246926.7, authorized on Aug. 31, 2018, the color-protecting solution is made up of three substances containing vitamin, citric acid and natamycin in proportion. Modified atmosphere packaging is used in the preserving method, in which the soaked fresh-cut apples are put into a packaging bag and 22% oxygen and 4% carbon dioxide are injected into the packaging bag to keep the apples fresh. However, there are some problems in the patent. First, the molecular structure of natamycin belongs to polyene macrolide that is easy to be photolyzed by influence of the ultraviolet light, and the preservation effect will be affected since the proportion of natamycin in this formula is large. Second, the aeration concentration of the modified atmosphere packaging chosen in this preservation method is difficult to be controlled accurately and the operability is poor in actual production, and the atmosphere balance in the packaging is easy to be destroyed since the breathing effect of the fresh-cut fruits will be enhanced after being cut, thus the preservation effect will be reduced. Third, in this method, the fresh-cut fruits and vegetables taken out are directly packaged without being completely drained, resulting in excessive humidity in the bag, which is prone to breed microorganisms.

In a second compared patent “Preparation Method and Application of a Fresh-cut Fruit and Vegetable Preservative” numbered ZL201510745990.6, authorized on Feb. 12, 2019, a mixed solution is obtained by adding chitosan to a buffer solution, and then gallic acid and enzyme preparation are added to the mixed solution. A chitosan gallic acid derivative can be obtained after stirring the mixed solution at room temperature for 8 hours. The fresh-cut fruit and vegetable preservative according to the invention can be obtained after freezing and drying the chitosan gallic acid derivative. There are some problems in the patent. First, the preservative needs to be twice dissolved to use, which may easily reduce the preservation effect of the preservative, since the preservative is difficult to be evenly distributed on the surface of the fruits and vegetables during spraying. Second, the gallic acid used in this patent belongs to a chemical reagent and accounts for a relatively large amount, although it can play a role in color protection and freshness preservation, the long-term accumulation of chemical reagents in the human body will cause certain safety risks.

In a third compared patent “A Browning Inhibitor of Fresh-cut Fruits and Vegetables and Preparation Method thereof” numbered ZL201510234403.7, authorized on Jun. 8, 2018, a compound preservative is obtained using a novel tyrosinase inhibitor and vitamin C through compounding, which has a good effect of inhibiting the browning of the fresh fruit and vegetable slices. There are problems in the patent. First, the browning inhibitor is mainly used to prevent browning, has a single function, and is not widely used. Second, the browning inhibitor is a short-term effective inhibitor with time-effectiveness, and the effect is obvious within 48 hours, which is not conducive to the long-term color preservation and freshness preservation of the fresh-cut fruits.

The above-mentioned patents and the present application are quite different in the fresh-keeping preparations and methods, and they can't affect the novelty and creativity of the present application.

### SUMMARY OF PRESENT INVENTION

In order to overcome the shortcomings of the prior art, a color-protecting bacteriostatic crisp-preserving fresh-cut apple and biological coating preservation technology is provided in the present disclosure, which has a novel composition and a good bacteriostatic effect.

The technical solutions of the present disclosure are as follows.

A fresh-keeping preparation for green color-protecting bacteriostatic crisp-preserving fresh-cut sweetheart apples is provided, the ingredients are as follows:

two fermentation liquids of Xanthomonas campestris and Lactobacillus plantarum are separately fermented, and are removal of the bacterial species, and then mixed in the ratio of 1:1 to obtain a bacterial solution, the bacterial solution is diluted 20-30 times for use, and then calcium chloride with a final concentration of 1-5 wt % is added to the bacterial solution.

A fresh-keeping and color protecting method for green color-protecting bacteriostatic crisp-preserving fresh-cut sweetheart apples is provided, the steps are as follows:

1) pre-treatment of the apple: selecting a ripe apple without skin damage and with uniform size and uniform maturity;
2) cleaning with ozone water: putting the selected apple in 1.8 mg/L ozone water, soaking and cleaning it for 5 minutes to remove the dirt and impurities on its surface and carry out the preliminary sterilization;
3) draining: taking out the apple and drying it at room temperature and in ventilated environment;
4) immersing in a color-protecting crisp-preserving biological coating solution: putting the apple in the compound bacteria solution that has 1-5 wt % calcium chloride at a temperature of 30° C. for 10-15 minutes; subsequently, using a sterilized sterile ceramic knife to peel and core the apple, and to cut the apple into fresh-cut apple slices with a thickness of 0.8-1 cm, taking out the and draining the slices;
5) CO₂ inflatable packaging combined with ionizing radiation sterilization: in the modified atmosphere packaging process, making 18.00 cm×17.00 cm bags from PE (polyethylene) films with a thickness of 55.00 μm, putting 10 slices into each bag, the weight of each bag of slices is about 80.00 g, and filling each bag with carbon dioxide gas, and then sterilizing the bag by ionizing radiation;
6) low-temperature storage: putting the processed fresh-cut apple slices into a cold storage for storage, the temperature of the cold storage is set to 0° C.

Moreover, the preparation process of the compound bacterial solution is as follows:

separately fermenting Xanthomonas campestris CGMCC1.1781 and Lactobacillus plantarum CICC23941 for 20 hours to obtain two bacterial solutions, and removing the bacterial species, then mixing the solutions in the ratio of 1:1 and diluting the mixed solution 20-30 times for use.

The advantages and positive effects of the present disclosure are as follows.

1. A novel color-protecting crisp-preserving biological coating solution is used in the present disclosure.

The extracellular polysaccharide produced by the metabolism of xanthomonas, namely the xanthan gum, is a safe food additive, which has good film-forming, thickening, stabilizing and water-holding effects, and strong biological activity such as anti-tumor and anti-ulcer. Acidic substances produced by the metabolism of Lactobacillus plantarum, such as acetic acid, lactic acid, and propionic acid, have bacteriostatic effects. Calcium plays an important role in the formation of cell membranes, and maintains the stability of the structure and performance of the protoplast membrane, and also maintains the integrity of the fruit body, so it is a common substance used to keep the fruits and vegetables crisp after harvest.

With the help of a low-strength static magnetic field, the phospholipid molecular chains in the cell membrane of xanthomonas are re-aligned, and the protein subunit ion channels on the membrane are deformed, thus motivating the ions such as Ca2+ and Na+ to move into and out of the cell. Therefore, the splitting and multiplying ability of xanthomonas is enhanced, the activity is increased, and the xanthan gum, the product fermented per unit time is increased for subsequent use.

The xanthan gum produced by xanthomonas is used as a film-forming agent and bacteriostatic agent while the fermentation liquid of Lactobacillus plantarum is used as the main bacteriostatic substance, in order to achieve the effect of bacteriostasis and synergism. Since the bacteriostatic ingredients are complex, it is difficult for the pathogenic bacteria to become drug resistant. Then an appropriate amount of calcium chloride is added to it to make the color-protecting crisp-preserving biological coating solution with bacteriostatic function.

2. A low-temperature color-protecting coating and aseptic cutting technology is used in the present disclosure.

The apple is put in an ozone pool at a temperature of 0° C. and cleaned to preliminarily sterilize and remove the dust and impurities as well as reduce the enzyme activity in the apple. After being taken out the drained, the apple is placed in an aseptic box at a temperature of 0 C and then put into the bacteriostatic color-protecting crisp-preserving biological coating solution filled with nitrogen circulation. Under the double protection of nitrogen and the color-protecting solution, the apple is cut in the solution by the sterile ceramic knife for segmentation, which can achieve the effect of cutting and coating at the same time, so as to achieve the effect of no contact with the outside world during cutting of the apple, and the timely application of the coating agent on the cut can slow down the loss of nutrients on the cut of the apple. Finally, the fresh-cut apple slices are taken out from the bacteriostatic solution and drained in the sterile box at a temperature of 0° C., and then immediately packaged.

3. A technology of CO₂ inflatable packaging combined with ionizing radiation sterilization is used in the present disclosure.

Only CO₂ gas is used to inflate the package, which can effectively inhibit the breathing effect of the fruits and vegetables, and the operation is simple. The infinitesimal remaining oxygen in the packaging, produced from the breathing of the fruits and vegetables and other factors, can be converted to peroxide under the ionizing radiation, which can indirectly kill the bacteria, thus helping to enhance the sterilization effect of the ionizing radiation. The ionizing radiation sterilization is a cold sterilization technology that does not affect the sensory quality of the apple slices in the package.

### DETAILED DESCRIPTION OF PREFERRED EMBODIMENTS

The present disclosure will be further described in detail below through specific embodiments. The following embodiments are only descriptive but not limitative, and cannot limit the scope of the present disclosure.

A fresh-keeping preparation for green color-protecting bacteriostatic crisp-preserving fresh-cut sweetheart apples is provided, the ingredients are as follows.

Xanthomonas campestris CGMCC1.1781 and Lactobacillus plantarum CICC23941 are separately fermented for 20 hours to obtain two bacterial solutions, and the bacterial species are removed, then the solutions are mixed in the ratio of 1:1 and diluted 20-30 times for use, and then calcium chloride with a final concentration of 1-5 wt % is added to the mixed bacterial solution.

A fresh-keeping and color protecting method for green color-protecting bacteriostatic crisp-preserving fresh-cut sweetheart apples is provided, the steps are as follows:

1) pre-treatment of the apple: selecting a ripe apple without skin damage and with uniform size and uniform maturity;
2) cleaning with ozone water: putting the selected apple in 1.8 mg/L ozone water, soaking and cleaning it for 5 minutes to remove the dirt and impurities on its surface and carry out the preliminary sterilization;
3) draining: taking out the apple and drying it at room temperature and in ventilated environment;
4) immersing in a color-protecting crisp-preserving biological coating solution: putting the apple in the compound bacteria solution that has 1-5 wt % calcium chloride at a temperature of 30° C. for 10-15 minutes; subsequently, using a sterilized sterile ceramic knife to peel and core the apple, and to cut the apple into fresh-cut apple slices with a thickness of 0.8-1 cm, taking out the and draining the slices;
5) CO₂ inflatable packaging combined with ionizing radiation sterilization: in the modified atmosphere packaging process, making 18.00 cm×17.00 cm bags from PE (polyethylene) films with a thickness of 55.00 μm, putting 10 slices into each bag, the weight of each bag of slices is about 80.00 g, and filling each bag with carbon dioxide gas, and then sterilizing the bag by ionizing radiation;
6) low-temperature storage: putting the processed fresh-cut apple slices into a cold storage for storage, the temperature of the cold storage is set to 0° C.

Wherein, the preparation process of the compound bacterial solution is as follows:

separately fermenting Xanthomonas campestris CGMCC1.1781 and Lactobacillus plantarum CICC23941 for 20 hours to obtain two bacterial solutions, and removing the bacterial species, then mixing the solutions in the ratio of 1:1 and diluting the mixed solution 20-30 times for use.

The quality indexes of the apple slices preserved with the preservation solution are detected as follows (having preserved for 60 days).

| Quality index | Parameter | |
|---|---|---|
| Sensory Quality | Bright color, compact texture, crisp fruit | |
| POD Activity | 4.8/U · g-1FW · mm-1 | |
| PPO Activity | 0.9/U · g-1FW · mm-1 | |
| MDA | 0.9/U · g-1FW · mm-1 | |
| Vc | 6.8 | mg/100 g |
| TA | 28% | |
| SSC | 14% | |
| Hardness | 9.2 | kg/cm2 |

| | |
|---|---|
| Browning Degree ΔE | 6.83 |

We claim:

1. A fresh-keeping preparation for green color-protecting bacteriostatic crisp-preserving fresh-cut sweetheart apples, wherein, the ingredients are as follows:
two fermentation liquids of Xanthomonas campestris and Lactobacillus plantarum are separately fermented, and are removal of the bacterial species, and then mixed in the ratio of 1:1 to obtain a bacterial solution, the bacterial solution is diluted 20-30 times for use, and then calcium chloride with a final concentration of 1-5 wt % is added to the bacterial solution.

2. A fresh-keeping and color protecting method for green color-protecting bacteriostatic crisp-preserving fresh-cut sweetheart apples, wherein, the steps are as follows:
1) pre-treatment of the apple: selecting a ripe apple without skin damage and with uniform size and uniform maturity;
2) cleaning with ozone water: putting the selected apple in 1.8 mg/L ozone water, soaking and cleaning it for 5 minutes to remove the dirt and impurities on its surface and carry out the preliminary sterilization;
3) draining: taking out the apple and drying it at room temperature and in ventilated environment;
4) immersing in a color-protecting crisp-preserving biological coating solution: putting the apple in a compound bacteria solution that has 1-5 wt % calcium chloride at a temperature of 30° C. for 10-15 minutes; subsequently, using a sterilized sterile ceramic knife to peel and core the apple, and to cut the apple into fresh-cut apple slices with a thickness of 0.8-1 cm, taking out the and draining the slices;
5) CO₂ inflatable packaging combined with ionizing radiation sterilization: in the modified atmosphere packaging process, making 18.00 cm×17.00 cm bags from PE (polyethylene) films with a thickness of 55.00 μm, putting 10 slices into each bag, the weight of each bag of slices is about 80.00 g, and filling each bag with carbon dioxide gas, and then sterilizing the bag by ionizing radiation;
6) low-temperature storage: putting the processed fresh-cut apple slices into a cold storage for storage, the temperature of the cold storage is set to 0° C.

3. The fresh-keeping and color protecting method for green color-protecting bacteriostatic crisp-preserving fresh-cut sweetheart apples according to claim 2, wherein the preparation process of the compound bacterial solution is as follows:
separately fermenting Xanthomonas campestris CGMCC1.1781 and Lactobacillus plantarum CICC23941 for 20 hours to obtain two bacterial solutions, and removing the bacterial species, then mixing the solutions in the ratio of 1:1 and diluting the mixed solution 20-30 times for use.
